(19) United States
(12) Patent Application Publication
(10) Pub. No.: US 2025/0074819 A1
(43) Pub. Date: Mar. 6, 2025

(54) Low Carbon Footprint Plaster Composition

(71) Applicant: Gold Bond Building Products, LLC, Charlotte, NC (US)

(72) Inventors: Eli Stav, Charlotte, NC (US); Kelly Guinsler, Marvin, NC (US); Mark Chapman, Indian Land, SC (US); Craig Robertson, Charlotte, NC (US)

(21) Appl. No.: 18/817,697

(22) Filed: Aug. 28, 2024

Related U.S. Application Data
(60) Provisional application No. 63/535,710, filed on Aug. 31, 2023.

(51) Int. Cl. C04B 14/26; C04B 7/34; C04B 11/30; C04B 24/38; C04B 28/12; C04B 28/14; C04B 103/20; C04B 103/30; C04B 103/44

(52) U.S. Cl. CPC C04B 14/26; C04B 7/34; C04B 11/30; C04B 24/383; C04B 28/12; C04B 28/14; C04B 2103/20; C04B 2103/304; C04B 2103/44; C04B 2201/10; C04B 2201/20

(57) ABSTRACT

The present invention is directed to a plaster composition with a reduced carbon footprint and a method of making and using such plaster composition. In one aspect, the plaster composition may include a workability composition and a binder. When hydrated with water, a hydrated plaster composition may have enhanced workability, enhanced surface texture, enhanced finish, and may have a reduced carbon footprint as compared to a traditional plaster composition.

### RELATED APPLICATIONS

The present application is based on and claims priority to U.S. Provisional Patent Application Ser. No. 63/535,710, filed on Aug. 31, 2023, which is incorporated herein by reference in its entirety.

### BACKGROUND

Plaster compositions are commonly used in the construction industry for wall finishing, surface repair, and/or decorative molding. For wall finishing, a plaster composition may be used to create a durable finish on a surface that is optionally smooth and/or aesthetically appealing. For surface repair, a plaster composition may be used to repair uneven surfaces, such as surfaces having cracks, depressions, holes, and more generally imperfections. Notably, in modern times, corporate sustainability initiatives and national environmental initiatives have become increasingly prominent and influential. Particularly, the reduction of carbon emissions is a significant consideration in the construction industry. However, many products utilized in the construction industry, such as plaster compositions, traditionally have a significant carbon footprint.

Thus, there is a need to provide an improved plaster composition with a reduced carbon footprint.

### SUMMARY OF THE INVENTION

Aspects and advantages of the invention will be set forth in part in the following description, or may be obvious from the description, or may be learned through practice of the invention.

In accordance with one embodiment of the present invention, a plaster composition is disclosed. The plaster composition comprises: a workability composition, the workability composition being present in the plaster composition in an amount from about 1 wt. % to about 40 wt. %; the workability composition having a median particle size from about 0.1 microns to about 60 microns; and a binder.

In accordance with another embodiment of the present invention, a plaster composition is disclosed. The plaster composition comprises: a workability composition, the workability composition being present in the plaster composition in an amount from about 1 wt. % to about 40 wt. %, the workability composition having a particle size distribution such that from about 20 wt. % to about 80 wt. % of the workability composition has a particle size of less than about 5.5 microns; a binder; and a first stucco composition.

In accordance with a further embodiment of the present invention, a plaster composition is disclosed. The plaster composition comprises: a workability composition, the workability composition being present in the plaster composition in an amount from about 1 wt. % to about 40 wt. %; an air entraining agent, wherein at least one component of the air entraining agent has a carbon chain length from about 8 carbons to about 24 carbons; and a first stucco composition.

### DETAILED DESCRIPTION

Reference now will be made in detail to various embodiments. Each example is provided by way of explanation of the embodiments, not as a limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Generally speaking, the present invention is directed to a plaster composition. The plaster composition may include one or more thickeners, one or more air entraining agents, one or more workability compositions, one or more binders, one or more stucco compositions, one or more retarders, one or more stabilizers, or a combination thereof. The present inventors have discovered that the plaster composition disclosed herein provides various advantages. For instance, when combined with a liquid (e.g., water), a hydrated plaster composition in accordance with the present disclosure may have enhanced workability, enhanced surface texture, enhanced finish, and may have a reduced carbon footprint as compared to a traditional plaster composition.

It should be understood that throughout the entirety of this specification, each numerical value (e.g., weight percentage, concentration) disclosed should be read as modified by the term “about” (unless already expressly so modified) and then read again as not to be so modified. For instance, a value of “100” is to be understood as disclosing “100” and “about 100”. Further, it should be understood that throughout the entirety of this specification, when a numerical range (e.g., weight percentage, concentration) is described, any and every amount of the range, including the end points and all amounts therebetween, is disclosed. For instance, a range of “1 to 100”, is to be understood as disclosing both a range of “1 to 100 including all amounts therebetween” and a range of “about 1 to about 100 including all amounts therebetween”. The amounts therebetween may be separated by any incremental value. Notably, some aspects of the present invention may omit one or more of the features disclosed herein.

Generally, any of the components of the plaster composition may be in the form of a solid (e.g., powder, granules). In some aspects, the plaster composition may comprise a workability composition, such as limestone or dolomitic rock. As used herein, a “workability composition” is a composition that enhances the workability and/or smoothness properties of a plaster composition. Generally, workability refers to the ease with which the plaster composition is placed, shaped, floated, and/or tooled. Notably, plaster compositions traditionally utilized in the construction industry generally comprise slaked lime and/or dolomitic slaked lime. Slaked lime is generally formed by the heating of limestone to release carbon dioxide, which is then followed by the slaking of the decarbonated lime in water to form a composition comprising calcium hydroxide. The composition comprising calcium hydroxide may be referred to as slaked lime. Dolomitic slaked lime is formed by the heating of dolomite to release carbon dioxide, which is then followed by slaking of the decarbonated dolomitic lime in water to form a composition comprising calcium hydroxide and magnesium hydroxide. The composition comprising calcium hydroxide and magnesium hydroxide may be referred to as dolomitic slaked lime. In general, the plaster composition of the present disclosure may be formed with a reduced amount of slaked lime and/or dolomitic slaked lime, which may lower the carbon footprint of the plaster composition. However, it should be understood that a plaster composition formed in accordance with the present disclosure may comprise slaked lime and/or dolomitic slaked lime.

In general, a plaster composition formed in accordance with the present disclosure may include slaked lime and/or dolomitic slaked lime in an amount from about 0 wt. % to about 20 wt. %, including all increments of 0.01 wt. % therebetween. In this respect, the plaster composition may include slaked lime and/or dolomitic slaked lime in an amount of about 0 wt. % or more, such as about 0.1 wt. % or more, such as about 0.5 wt. % or more, such as about 1 wt. % or more, such as about 2 wt. % or more, such as about 3 wt. % or more, such as about 4 wt. % or more, such as about 5 wt. % or more, such as about 6 wt. % or more, such as about 7 wt. % or more, such as about 8 wt. % or more, such as about 9 wt. % or more, such as about 10 wt. % or more, such as about 12 wt. % or more, such as about 14 wt. % or more, such as about 16 wt. % or more, such as about 18 wt. % or more. In general, the plaster composition may include slaked lime and/or dolomitic slaked lime in an amount of about 20 wt. % or less, such as about 18 wt. % or less, such as about 16 wt. % or less, such as about 14 wt. % or less, such as about 12 wt. % or less, such as about 10 wt. % or less, such as about 9 wt. % or less, such as about 8 wt. % or less, such as about 7 wt. % or less, such as about 6 wt. % or less, such as about 5 wt. % or less, such as about 4 wt. % or less, such as about 3 wt. % or less, such as about 2 wt. % or less, such as about 1 wt. % or less, such as about 0.5 wt. % or less, such as about 0.1 wt. % or less. Notably, a plaster composition formed in accordance with the present disclosure may be free or substantially free of slaked lime and/or dolomitic slaked lime. As used herein, a plaster composition “substantially free” of slaked lime and/or dolomitic slaked lime has a slaked lime and/or dolomitic slaked lime content of less than about 2 wt. %, such as 0.1 wt. % or less, such as 0.01 wt. % or less.

As previously disclosed herein, the plaster composition may comprise a workability composition. In general, the workability composition may comprise limestone and/or dolomitic rock. Notably, a workability composition of the plaster composition may be ground or milled, such as by dry milling or wet milling. In one particular aspect, a workability composition may be ball-milled, such as by a planetary ball mill. In this respect, in one aspect, limestone and/or dolomitic rock may be ball-milled to form at least one component of a plaster composition. The milling of a workability composition may be particularly advantageous. Notably, a workability composition may enhance the workability, enhance the surface texture, enhance the finish, and/or reduce the carbon footprint of a plaster composition.

As previously disclosed herein, a workability composition may be ball-milled, such as by a planetary ball mill. However, it should be understood that a workability composition may be milled or ground by other equipment such as, for instance, an attritor, a vibration mill, an impact mill, a jet mill, and the like. Notably, a workability composition may be milled or ground before being incorporated into the plaster composition.

In general, a workability composition may have a median particle size from about 0.1 microns to about 60 microns, including all increments of 0.1 microns therebetween. For instance, a workability composition may have a median particle size of about 0.1 microns or more, such as about 1 micron or more, such as about 2 microns or more, such as about 3 microns or more, such as about 4 microns or more, such as about 5 microns or more, such as about 6 microns or more, such as about 7 microns or more, such as about 8 microns or more, such as about 9 microns or more, such as about 10 microns or more, such as about 12 microns or more, such as about 15 microns or more, such as about 18 microns or more, such as about 20 microns or more, such as about 25 microns or more, such as about 30 microns or more, such as about 35 microns or more, such as about 40 microns or more, such as about 45 microns or more, such as about 50 microns or more. In general, a workability composition may have a median particle size of about 60 microns or less, such as about 50 microns or less, such as about 45 microns or less, such as about 40 microns or less, such as about 35 microns or less, such as about 30 microns or less, such as about 25 microns or less, such as about 20 microns or less, such as about 18 microns or less, such as about 15 microns or less, such as about 12 microns or less, such as about 10 microns or less, such as about 9 microns or less, such as about 8 microns or less, such as about 7 microns or less, such as about 6 microns or less, such as about 5 microns or less, such as about 4 microns or less, such as about 3 microns or less, such as about 2 microns or less, such as about 1 micron or less. Notably, a workability composition may have a D₁₀, D₅₀, or D₉₀ of any of the values previously disclosed, including any incremental values therebetween. Furthermore, in one aspect, the aforementioned values, including any incremental values therebetween, may refer to an average particle size of a workability composition. Notably, a workability composition may be ground or milled to have a median particle size and/or average particle size from about 0.1 microns to about 60 microns, including all increments of 0.1 microns therebetween.

The workability composition may have a selectively chosen particle size distribution. The particle size distribution of the workability composition may be monomodal, bi-modal, or multi-modal. In one aspect, a US standard mesh size of 3½ may retain from about 0 wt. % to about 100 wt. % of a workability composition, including all increments of 0.01 wt. % therebetween. For instance, a US standard mesh size of 3½ may retain about 0 wt. % of the workability composition or more, such as about 10 wt. % or more, such as about 20 wt. % or more, such as about 30 wt. % or more, such as about 40 wt. % or more, such as about 50 wt. % or more, such as about 60 wt. % or more, such as about 70 wt. % or more, such as about 80 wt. % or more, such as about 90 wt. % or more, such as about 100 wt. % or less, such as about 90 wt. % or less, such as about 80 wt. % or less, such as about 70 wt. % or less, such as about 60 wt. % or less, such as about 50 wt. % or less, such as about 40 wt. % or less, such as about 30 wt. % or less, such as about 20 wt. % or less, such as about 10 wt. % or less. In one aspect, a US standard mesh size of 325 may retain from about 0 wt. % to about 5 wt. % of the workability composition, such as about 0 wt. % or more, such as about 0.001 wt. % or more, such as about 0.005 wt. % or more, such as about 0.01 wt. % or more, such as about 0.05 wt. % or more, such as about 0.1 wt. % or more, such as about 0.5 wt. % or more, such as about 1 wt. % or more, such as about 2 wt. % or more, such as about 3 wt. % or more, such as about 4 wt. % or more In general, a US standard mesh size of 325 may retain about 5 wt. % or less of the workability composition, such as about 4 wt. % or less, such as about 3 wt. % or less, such as about 2 wt. % or less, such as about 1 wt. % or less, such as about 0.5 wt. % or less, such as about 0.1 wt. % or less, such as about 0.05 wt. % or less, such as about 0.01 wt. % or less, such as about 0.005 wt. % or less.

In one aspect, the workability composition may have a particle size distribution such that from about 20% to about 80% of the particles of the workability composition by volume percent and/or by weight percent have a particle size of less than 5.5 microns, which may be determined by a laser diffractometer, such as a Microtrac S3500. For instance, the workability composition may contain particles having a particle size less than 5.5 microns in an amount of about 20% or more, such as about 30% or more, such as about 40% or more, such as about 50% or more, such as about 60% or more, such as about 70% or more. In general, the workability composition may contain particles having a particle size less than 5.5 microns in an amount of about 80% or less, such as about 70% or less, such as about 60% or less, such as about 50% or less, such as about 40% or less, such as about 30% or less. The aforementioned percentage values may be based on volume percent and/or weight percent of the workability composition.

In general, a workability composition may have a bulk density from about 400 kg/m³ to about 1400 kg/m³, including all increments of 1 kg/m³ therebetween. For instance, a workability composition may have a bulk density of about 400 kg/m³ or more, such as about 500 kg/m³ or more, such as about 600 kg/m³ or more, such as about 700 kg/m³ or more, such as about 800 kg/m³ or more, such as about 900 kg/m³ or more, such as about 1000 kg/m³ or more, such as about 1100 kg/m³ or more, such as about 1200 kg/m³ or more, such as about 1300 kg/m³ or more. In general, a workability composition may have a bulk density of about 1400 kg/m³ or less, such as about 1300 kg/m³ or less, such as about 1200 kg/m³ or less, such as about 1100 kg/m³ or less, such as about 1000 kg/m³ or less, such as about 900 kg/m³ or less, such as about 800 kg/m³ or less, such as about 700 kg/m³ or less, such as about 600 kg/m³ or less, such as about 500 kg/m³ or less.

Generally, a workability composition may comprise one or more metal carbonates (e.g., calcium carbonate, magnesium carbonate), one or more silicates, or a combination thereof. For instance, in one aspect, a workability composition may comprise one or more metal carbonates in an amount from about 50 wt. % to about 100 wt. %, including all increments of 0.01 wt. % therebetween. In this respect, a workability composition may comprise one or more metal carbonates in an amount of about 50 wt. % or more, such as about 60 wt. % or more, such as about 70 wt. % or more, such as about 80 wt. % or more, such as about 85 wt. % or more, such as about 88 wt. % or more, such as about 90 wt. % or more, such as about 92 wt. % or more, such as about 94 wt. % or more, such as about 96 wt. % or more, such as about 98 wt. % or more. In general, a workability composition may comprise one or more metal carbonates in an amount of about 100 wt. % or less, such as about 98 wt. % or less, such as about 96 wt. % or less, such as about 94 wt. % or less, such as about 92 wt. % or less, such as about 90 wt. % or less, such as about 88 wt. % or less, such as about 85 wt. % or less, such as about 80 wt. % or less, such as about 70 wt. % or less, such as about 60 wt. % or less.

In one aspect, a workability composition may comprise one or more silicates (e.g., quartz) in an amount from about 0 wt. % to about 15 wt. %, including all increments of 0.01 wt. % therebetween. For instance, a workability composition may comprise one or more silicates in an amount of about 0 wt. % or more, such as about 1 wt. % or more, such as about 2 wt. % or more, such as about 3 wt. % or more, such as about 4 wt. % or more, such as about 5 wt. % or more, such as about 6 wt. % or more, such as about 7 wt. % or more, such as about 8 wt. % or more, such as about 10 wt. % or more. In general, a workability composition may comprise one or more silicates in an amount of about 15 wt. % or less, such as about 10 wt. % or less, such as about 8 wt. % or less, such as about 7 wt. % or less, such as about 6 wt. % or less, such as about 5 wt. % or less, such as about 4 wt. % or less, such as about 3 wt. % or less, such as about 2 wt. % or less, such as about 1 wt. % or less.

In general, the workability composition may be present in the plaster composition in an amount from about 1 wt. % to about 40 wt. %, including all increments of 0.01 wt. % therebetween. In this respect, the workability composition may be present in the plaster composition in an amount of about 1 wt. % or more, such as about 2 wt. % or more, such as about 3 wt. % or more, such as about 4 wt. % or more, such as about 5 wt. % or more, such as about 6 wt. % or more, such as about 7 wt. % or more, such as about 8 wt. % or more, such as about 9 wt. % or more, such as about 10 wt. % or more, such as about 11 wt. % or more, such as about 12 wt. % or more, such as about 13 wt. % or more, such as about 14 wt. % or more, such as about 15 wt. % or more, such as about 16 wt. % or more, such as about 17 wt. % or more, such as about 18 wt. % or more, such as about 19 wt. % or more, such as about 20 wt. % or more, such as about 22 wt. % or more, such as about 25 wt. % or more, such as about 28 wt. % or more, such as about 30 wt. % or more, such as about 35 wt. % or more. In general, the workability composition may be present in the plaster composition in an amount of about 40 wt. % or less, such as about 35 wt. % or less, such as about 30 wt. % or less, such as about 28 wt. % or less, such as about 25 wt. % or less, such as about 22 wt. % or less, such as about 20 wt. % or less, such as about 19 wt. % or less, such as about 18 wt. % or less, such as about 17 wt. % or less, such as about 16 wt. % or less, such as about 15 wt. % or less, such as about 14 wt. % or less, such as about 13 wt. % or less, such as about 12 wt. % or less, such as about 11 wt. % or less, such as about 10 wt. % or less, such as about 9 wt. % or less, such as about 8 wt. % or less, such as about 7 wt. % or less, such as about 6 wt. % or less, such as about 5 wt. % or less, such as about 4 wt. % or less, such as about 3 wt. % or less, such as about 2 wt. % or less.

Generally, the plaster composition may comprise one or more stucco compositions (e.g., a first stucco composition, a second stucco composition). The stucco may be from a natural source, a synthetic source, and/or reclaim and is thus not necessarily limited by the present invention. Notably, the stucco composition may include calcium sulfate hemihydrate (e.g., α-hemihydrate, β-hemihydrate), anhydrite (e.g., AII, AIII), or a mixture thereof.

A stucco composition formed in accordance with the present disclosure may have a bulk density from about 400 kg/m³ to about 1600 kg/m³, including all increments of 1 kg/m³ therebetween. For instance, a stucco composition may have a bulk density of about 400 kg/m³ or more, such as about 500 kg/m³ or more, such as about 600 kg/m³ or more, such as about 700 kg/m³ or more, such as about 800 kg/m³ or more, such as about 900 kg/m³ or more, such as about 1000 kg/m³ or more, such as about 1100 kg/m³ or more, such as about 1200 kg/m³ or more, such as about 1300 kg/m³ or more, such as about 1400 kg/m³ or more, such as about 1500 kg/m³ or more. In general, a stucco composition may have a bulk density of about 1600 kg/m³ or less, such as about 1500 kg/m³ or less, such as about 1400 kg/m³ or less, such as about 1300 kg/m³ or less, such as about 1200 kg/m³ or less, such as about 1100 kg/m³ or less, such as about 1000 kg/m³ or less, such as about 900 kg/m³ or less, such as about 800 kg/m³ or less, such as about 700 kg/m³ or less, such as about 600 kg/m³ or less, such as about 500 kg/m³ or less.

A stucco composition formed in accordance with the present disclosure may have a pH from 4 to 10, including all increments of 1 pH therebetween. For instance, a stucco composition may have a pH of 4 or more, such as 5 or more, such as 6 or more, such as 7 or more, such as 8 or more, such as 9 or more. In general, a stucco composition may have a pH of 10 or less, such as 9 or less, such as 8 or less, such as 7 or less, such as 6 or less, such as 5 or less.

In general, a stucco composition (e.g., a first stucco composition, a second stucco composition) may have a calcium sulfate hemihydrate content from about 50 wt. % to about 100 wt. %, including all increments of 0.01 wt. % therebetween. For instance, a stucco composition (e.g., a first stucco composition, a second stucco composition) may have a calcium sulfate hemihydrate content of about 50 wt. % or more, such as about 60 wt. % or more, such as about 70 wt. % or more, such as about 75 wt. % or more, such as about 80 wt. % or more, such as about 85 wt. % or more, such as about 90 wt. % or more, such as about 95 wt. % or more, such as about 100 wt. % or less, such as about 95 wt. % or less, such as about 90 wt. % or less, such as about 85 wt. % or less, such as about 80 wt. % or less, such as about 75 wt. % or less, such as about 70 wt. % or less, such as about 60 wt. % or less.

A stucco composition (e.g., a first stucco composition, a second stucco composition) may have a selectively chosen particle size distribution. The particle size distribution of a stucco composition may be monomodal, bi-modal, or multi-modal. In one aspect, a US standard mesh size of 100 may retain from about 0 wt. % to about 30 wt. % of a stucco composition, including all increments of 0.01 wt. % therebetween. For instance, a US standard mesh size of 100 may retain about 0 wt. % of the stucco composition or more, such as about 5 wt. % or more, such as about 10 wt. % or more, such as about 15 wt. % or more, such as about 20 wt. % or more, such as about 25 wt. % or more. In general, a US standard mesh size of 100 may retain about 30 wt. % or less of a stucco composition, such as about 25 wt. % or less, such as about 20 wt. % or less, such as about 15 wt. % or less, such as about 10 wt. % or less, such as about 5 wt. % or less. In one aspect, a US standard mesh size of 325 may retain from about 20 wt. % to about 60 wt. % of the stucco composition, including all increments of 0.01 wt. % therebetween. For instance, a US standard mesh size of 325 may retain about 20 wt. % of the stucco composition or more, such as about 25 wt. % or more, such as about 30 wt. % or more, such as about 35 wt. % or more, such as about 40 wt. % or more, such as about 45 wt. % or more, such as about 50 wt. % or more, such as about 55 wt. % or more. In general, a US standard mesh size of 325 may retain about 60 wt. % or less of the stucco composition, such as about 55 wt. % or less, such as about 50 wt. % or less, such as about 45 wt. % or less, such as about 40 wt. % or less, such as about 35 wt. % or less, such as about 30 wt. % or less, such as about 25 wt. % or less.

In one aspect, the plaster composition may comprise a stucco composition (e.g., a first stucco composition, a second stucco composition) in an amount from about 20 wt. % to about 80 wt. %, including all increments of 0.01 wt. % therebetween. For instance, a stucco composition may be present in the plaster composition in an amount of about 20 wt. % or more, such as about 25 wt. % or more, such as about 30 wt. % or more, such as about 35 wt. % or more, such as about 40 wt. % or more, such as about 45 wt. % or more, such as about 50 wt. % or more, such as about 55 wt. % or more, such as about 60 wt. % or more, such as about 65 wt. % or more, such as about 70 wt. % or more, such as about 75 wt. % or more. In general, a stucco composition may be present in the plaster composition in an amount of about 80 wt. % or less, such as about 75 wt. % or less, such as about 70 wt. % or less, such as about 65 wt. % or less, such as about 60 wt. % or less, such as about 55 wt. % or less, such as about 50 wt. % or less, such as about 45 wt. % or less, such as about 40 wt. % or less, such as about 35 wt. % or less, such as about 30 wt. % or less, such as about 25 wt. % or less.

In general, the plaster composition may also include one or more binders. The binder may include an acetate polymer, an acrylic polymer, a polyvinyl alcohol, a cellulose polymer, a starch, etc., or a combination thereof. In one embodiment, the binder may include two or more of an acetate polymer, an acrylic polymer, a polyvinyl alcohol, a cellulose polymer, or a starch. For instance, in one embodiment, the binder may include at least a mixture of an acetate polymer and a cellulose polymer. In a further embodiment, the binder may include at least an acetate polymer. In another further embodiment, the binder may include at least a cellulose polymer.

The acetate polymer may include a vinyl acetate, such as an ethylene vinyl acetate. For instance, the acetate polymer may be a polyvinyl acetate, a polyethylene vinyl acetate, or a mixture thereof. In one embodiment, the acetate polymer may include polyvinyl acetate. In another embodiment, the acetate polymer may include polyethylene vinyl acetate. In an even further embodiment, the acetate polymer may be a mixture of two acetate polymers, such as any two of the aforementioned.

The acrylic polymer may be any acrylic polymer. For instance, the acrylic polymer may be a polyacrylate. In a further embodiment, the acrylic polymer may be a polyvinyl acrylic polymer. In another further embodiment, the acrylic polymer may be a polyvinyl acetate acrylate. In an even further embodiment, the acrylic polymer may be a mixture of two acrylic polymers, such as any two of the aforementioned.

The cellulose polymer may include one or more cellulose ethers. In general, a cellulose ether may provide for enhanced workability and water retention. Notably, the cellulose ether may act as a thixotropic agent. The cellulose ether may include hydroxyl groups are partially or fully replaced by —OR groups, wherein R is a substituted or substituted alkyl. For instance, the alkyl may be a C₁-C₆ alkyl. In particular, the alkyl may be methyl, ethyl, propyl, or a combination thereof. If a substitution is present, the substitution may include a hydroxy or a sulfo substitution. In addition, in one embodiment, the cellulose ether may be soluble in water at ambient temperature. In one embodiment, the cellulose ether may be nonionic. The cellulose ether may be an alkyl cellulose, a hydroxyalkyl cellulose, or a mixture thereof. The cellulose ether may include, but is not limited to methylcellulose, ethyl cellulose, propyl cellulose, butyl cellulose, hydroxyethyl methylcellulose, hydroxypropyl methylcellulose, hydroxypropylhydroxyethylcellulose, hydroxyethyl cellulose, ethylhydroxyethylcellulose, methylethylhydroxyethylcellulose, methylhydroxyethylcellulose, ethylmethylhydroxypropylcellulose, ethylhydroxyethylcellulose, a carboxyalkylcellulose (e.g., carboxymethylcellulose) etc., and mixtures thereof. The cellulose ether may have a particular degree of substitution (i.e., the average number of substituted hydroxyl groups per glucose united). The degree of substitution may be 0.1 or more, such as 0.2 or more, such as 0.3 or more, such as 0.5 or more, such as 1 or more, such as 1.3 or more, such as 1.5 or more, such as 2 or more. The degree of substitution may be 3 or less, such as 2.8 or less, such as 2.5 or less, such as 2.3 or less, such as 2 or less.

The binder may have a selectively chosen particle size distribution. The particle size distribution of the binder may be monomodal, bi-modal, or multi-modal. In one aspect, a US standard mesh size of 40 may retain from about 0 wt. % to about 30 wt. % of the binder, including all increments of 0.01 wt. % therebetween. For instance, a US standard mesh size of 40 may retain about 0 wt. % of the binder (e.g., hydroxyethyl cellulose) or more, such as about 5 wt. % or more, such as about 10 wt. % or more, such as about 15 wt. % or more, such as about 20 wt. % or more, such as about 30 wt. % or less, such as about 20 wt. % or less, such as about 15 wt. % or less, such as about 10 wt. % or less, such as about 5 wt. % or less.

In general, a binder may be present in the plaster composition in an amount from about 0.001 wt. % to about 5 wt. %, including all increments of 0.001 wt. % therebetween. For instance, a binder may be present in the plaster composition in an amount of about 0.001 wt. % or more, such as about 0.005 wt. % or more, such as about 0.01 wt. % or more, such as about 0.02 wt. % or more, such as about 0.03 wt. % or more, such as about 0.04 wt. % or more, such as about 0.05 wt. % or more, such as about 0.06 wt. % or more, such as about 0.07 wt. % or more, such as about 0.08 wt. % or more, such as about 0.09 wt. % or more, such as about 0.1 wt. % or more, such as about 0.15 wt. % or more, such as about 0.2 wt. % or more, such as about 0.3 wt. % or more, such as about 0.4 wt. % or more, such as about 0.5 wt. % or more, such as about 1 wt. % or more, such as about 2 wt. % or more, such as about 3 wt. % or more, such as about 4 wt. % or more. In general, a binder may be present in the plaster composition in an amount of about 5 wt. % or less, such as about 4 wt. % or less, such as about 3 wt. % or less, such as about 2 wt. % or less, such as about 1 wt. % or less, such as about 0.5 wt. % or less, such as about 0.4 wt. % or less, such as about 0.3 wt. % or less, such as about 0.2 wt. % or less, such as about 0.15 wt. % or less, such as about 0.1 wt. % or less, such as about 0.09 wt. % or less, such as about 0.08 wt. % or less, such as about 0.07 wt. % or less, such as about 0.06 wt. % or less, such as about 0.05 wt. % or less, such as about 0.04 wt. % or less, such as about 0.03 wt. % or less, such as about 0.02 wt. % or less, such as about 0.01 wt. % or less.

Generally, the plaster composition may comprise one or more thickeners. The one or more thickeners may comprise one or more starch ethers. In one aspect, a thickener may have a bulk density from about 300 kg/m³ to about 900 kg/m³, including all increments of 1 kg/m³ therebetween. For instance, a thickener of a plaster composition may have a bulk density of 300 kg/m³ or more, such as about 350 kg/m³ or more, such as about 400 kg/m³ or more, such as about 450 kg/m³ or more, such as about 500 kg/m³ or more, such as about 550 kg/m³ or more, such as about 600 kg/m³ or more, such as about 650 kg/m³ or more, such as about 700 kg/m³ or more, such as about 750 kg/m³ or more, such as about 800 kg/m³ or more, such as about 850 kg/m³ or more, such as about 900 kg/m³ or less, such as about 850 kg/m³ or less, such as about 800 kg/m³ or less, such as about 750 kg/m³ or less, such as about 700 kg/m³ or less, such as about 650 kg/m³ or less, such as about 600 kg/m³ or less, such as about 550 kg/m³ or less, such as about 500 kg/m³ or less, such as about 450 kg/m³ or less, such as about 400 kg/m³ or less, such as about 350 kg/m³ or less.

In one aspect, a thickener may have a viscosity from about 1 mPa·s to about 100 mPa·s, including all increments of 1 mPa-s therebetween. For instance, a thickener may have a viscosity of about 1 mPa·s or more, such as about 10 mPa·s or more, such as about 20 mPa-s or more, such as about 30 mPa-s or more, such as about 40 mPa·s or more, such as about 50 mPa-s or more, such as about 60 mPa·s or more, such as about 70 mPa·s or more, such as about 80 mPa·s or more, such as about 90 mPa·s or more. In general, a thickener may have a viscosity of about 100 mPa·s or less, such as about 90 mPa·s or less, such as about 80 mPa-s or less, such as about 70 mPa·s or less, such as about 60 mPa·s or less, such as about 50 mPa·s or less, such as about 40 mPa·s or less, such as about 30 mPa·s or less, such as about 20 mPa·s or less, such as about 10 mPa·s or less. The viscosity of the thickener may be determined by a falling ball viscometer, such as a Höeppler falling ball viscometer.

In general, a thickener may be present in the plaster composition in an amount from about 0.001 wt. % to about 5 wt. %, including all increments of 0.001 wt. % therebetween. For instance, a thickener may be present in the plaster composition in an amount of about 0.001 wt. % or more, such as about 0.005 wt. % or more, such as about 0.01 wt. % or more, such as about 0.02 wt. % or more, such as about 0.03 wt. % or more, such as about 0.04 wt. % or more, such as about 0.05 wt. % or more, such as about 0.06 wt. % or more, such as about 0.07 wt. % or more, such as about 0.08 wt. % or more, such as about 0.09 wt. % or more, such as about 0.1 wt. % or more, such as about 0.15 wt. % or more, such as about 0.2 wt. % or more, such as about 0.3 wt. % or more, such as about 0.4 wt. % or more, such as about 0.5 wt. % or more, such as about 1 wt. % or more, such as about 2 wt. % or more, such as about 3 wt. % or more, such as about 4 wt. % or more. In general, a thickener may be present in the plaster composition in an amount of about 5 wt. % or less, such as about 4 wt. % or less, such as about 3 wt. % or less, such as about 2 wt. % or less, such as about 1 wt. % or less, such as about 0.5 wt. % or less, such as about 0.4 wt. % or less, such as about 0.3 wt. % or less, such as about 0.2 wt. % or less, such as about 0.15 wt. % or less, such as about 0.1 wt. % or less, such as about 0.09 wt. % or less, such as about 0.08 wt. % or less, such as about 0.07 wt. % or less, such as about 0.06 wt. % or less, such as about 0.05 wt. % or less, such as about 0.04 wt. % or less, such as about 0.03 wt. % or less, such as about 0.02 wt. % or less, such as about 0.01 wt. % or less.

In one aspect, the plaster composition of the present disclosure may include one or more air entraining agents. The one or more air entraining agents may produce air bubbles, such as micro air bubbles, in the plaster composition that may enhance the workability of the plaster composition. In some aspects, the one or more air entraining agents may be soluble in water. In some aspects, the one or more air entraining agents may include a sulfate (e.g., alkyl ether sulfates), a sulfonate, a fatty acid (e.g., oleic acid, stearic acid), or a combination thereof.

In one aspect, an air entraining agent may be a sulfonate. In this respect, the one or more air entraining agents may include an alkane sulfonate, an alkene (e.g., an α-olefin) sulfonate, and/or an alkyl sulfonate. Notably, the one or more air entraining agents may include a counterion. For instance, the one or more air entraining agents may include sodium and/or potassium. In this respect, in some aspects, the one or more air entraining agents may include a sodium alkane sulfonate, a sodium alkene sulfonate (e.g., a sodium olefin sulfonate), an alpha olefin sulfonate, and/or a sodium alkyl sulfonate.

In general, an air entraining agent and/or any components thereof (e.g., a sulfonate) may have a carbon chain length from 8 carbons to 24 carbons, including all increments of 1 carbon therebetween. For instance, an air entraining agent and/or any components thereof (e.g., an olefin sulfonate) may have a carbon chain length of 8 carbons or more, such as 10 carbons or more, such as 12 carbons or more, such as 14 carbons or more, such as 16 carbons or more, such as 18 carbons or more, such as 20 carbons or more, such as 22 carbons or more. In general, an air entraining agent and/or any components thereof (e.g., an olefin sulfonate) may have a carbon chain length of 24 carbons or less, such as 22 carbons or less, such as 20 carbons or less, such as 18 carbons or less, such as 16 carbons or less, such as 14 carbons or less, such as 12 carbons or less, such as 10 carbons or less. The one or more air entraining agents and/or any components thereof may have a carbon chain length ranging from any of the values previously disclosed. For instance, an air entraining agent and/or any components thereof may have a carbon chain length of C₁₄₋₁₆, C₁₆₋₁₈, and/or C₁₄₋₁₈. Notably, one or more air entraining agents may include a sodium C₁₄₋₁₆ olefin sulfonate, a sodium C₁₄₋₁₈ olefin sulfonate, a sodium C₁₆₋₁₈ olefin sulfonate, or a combination thereof.

Generally, an air entraining agent of a plaster composition formed in accordance with the present disclosure may have a bulk density from about 50 kg/m³ to about 600 kg/m³, including all increments of 1 kg/m³ therebetween. For instance, an air entraining agent of a plaster composition formed in accordance with the present disclosure may have a bulk density of about 50 kg/m³ or more, such as about 100 kg/m³ or more, such as about 200 kg/m³ or more, such as about 300 kg/m³ or more, such as about 400 kg/m³ or more, such as about 500 kg/m³ or more, such as about 600 kg/m³ or less, such as about 500 kg/m³ or less, such as about 400 kg/m³ or less, such as about 300 kg/m³ or less, such as about 200 kg/m³ or less, such as about 100 kg/m³ or less.

In some aspects, an air entraining agent and/or any components (e.g., a sulfonate) thereof of a plaster composition may have a median particle size of from about 1 micron to about 300 microns, including all increments of 1 micron therebetween. For instance, an air entraining agent of a plaster composition formed in accordance with the present disclosure may have a median particle size of about 1 micron or more, such as about 10 microns or more, such as about 25 microns or more, such as about 50 microns or more, such as about 75 microns or more, such as about 100 microns or more, such as about 200 microns or more, such as about 300 microns or less, such as about 200 microns or less, such as about 100 microns or less, such as about 75 microns or less, such as about 50 microns or less, such as about 25 microns or less, such as about 10 microns or less. Furthermore, an air entraining agent and/or any components (e.g., a sulfonate) thereof may have a D₁₀, D₅₀, or D₉₀ of any of the values previously disclosed, including any incremental values therebetween. Notably, in one aspect, the aforementioned values, including any values therebetween, may refer to an average particle size of an air entraining agent and/or any components (e.g., a sulfonate) thereof.

In one aspect, an air entraining agent may include one or more metal carbonates. For instance, an air entraining agent may include sodium carbonate and/or potassium carbonate. In general, one or more metal carbonates may be present in an air entraining agent in an amount from about 0 wt. % to about 15 wt. %, including all increments of 0.01 wt. % therebetween. For instance, one or more metal carbonates (e.g., potassium carbonate) may be present in an air entraining agent in an amount of about 0 wt. % or more, such as about 0.01 wt. % or more, such as about 0.05 wt. % or more, such as about 0.1 wt. % or more, such as about 0.5 wt. % or more, such as about 1 wt. % or more, such as about 2 wt. % or more, such as about 3 wt. % or more, such as about 4 wt. % or more, such as about 5 wt. % or more, such as about 6 wt. % or more, such as about 8 wt. % or more, such as about 10 wt. % or more, such as about 12 wt. % or more, such as about 14 wt. % or more, such as about 15 wt. % or less, such as about 14 wt. % or less, such as about 12 wt. % or less, such as about 10 wt. % or less, such as about 8 wt. % or less, such as about 6 wt. % or less, such as about 5 wt. % or less, such as about 4 wt. % or less, such as about 3 wt. % or less, such as about 2 wt. % or less, such as about 1 wt. % or less, such as about 0.5 wt. % or less, such as about 0.1 wt. % or less, such as about 0.05 wt. % or less.

In general, an air entraining agent may be present in the plaster composition in an amount from about 0.001 wt. % to about 5 wt. %, including all increments of 0.001 wt. % therebetween. For instance, an air entraining agent may be present in the plaster composition in an amount of about 0.001 wt. % or more, such as about 0.005 wt. % or more, such as about 0.01 wt. % or more, such as about 0.02 wt. % or more, such as about 0.03 wt. % or more, such as about 0.04 wt. % or more, such as about 0.05 wt. % or more, such as about 0.06 wt. % or more, such as about 0.07 wt. % or more, such as about 0.08 wt. % or more, such as about 0.09 wt. % or more, such as about 0.1 wt. % or more, such as about 0.15 wt. % or more, such as about 0.2 wt. % or more, such as about 0.3 wt. % or more, such as about 0.4 wt. % or more, such as about 0.5 wt. % or more, such as about 1 wt. % or more, such as about 2 wt. % or more, such as about 3 wt. % or more, such as about 4 wt. % or more. In general, an air entraining agent may be present in the plaster composition in an amount of about 5 wt. % or less, such as about 4 wt. % or less, such as about 3 wt. % or less, such as about 2 wt. % or less, such as about 1 wt. % or less, such as about 0.5 wt. % or less, such as about 0.4 wt. % or less, such as about 0.3 wt. % or less, such as about 0.2 wt. % or less, such as about 0.15 wt. % or less, such as about 0.1 wt. % or less, such as about 0.09 wt. % or less, such as about 0.08 wt. % or less, such as about 0.07 wt. % or less, such as about 0.06 wt. % or less, such as about 0.05 wt. % or less, such as about 0.04 wt. % or less, such as about 0.03 wt. % or less, such as about 0.02 wt. % or less, such as about 0.01 wt. % or less.

Generally, the plaster composition may also include one or more retarders. In some aspects, the one or more retarders may include one or more organic retarders, one or more inorganic retarders, or a combination thereof. Notably, in one aspect, the one or more retarders may comprise organic retarders such as a proteinaceous retarder (e.g., SUMA retarder), a degraded mixture of polyamides, or a combination thereof. The one or more retarders may comprise one or more retarders that are salified. In this respect, in one aspect, the one or more retarders may comprise a degraded mixture of polyamides, salified with calcium.

In one aspect, one or more retarders may be present in the plaster composition in an amount from about 0.001 wt. % to about 5 wt. %, including all increments of 0.001 wt. % therebetween. For instance, a retarder may be present in the plaster composition in an amount of about 0.001 wt. % or more, such as about 0.005 wt. % or more, such as about 0.01 wt. % or more, such as about 0.02 wt. % or more, such as about 0.03 wt. % or more, such as about 0.04 wt. % or more, such as about 0.05 wt. % or more, such as about 0.06 wt. % or more, such as about 0.07 wt. % or more, such as about 0.08 wt. % or more, such as about 0.09 wt. % or more, such as about 0.1 wt. % or more, such as about 0.15 wt. % or more, such as about 0.2 wt. % or more, such as about 0.3 wt. % or more, such as about 0.4 wt. % or more, such as about 0.5 wt. % or more, such as about 1 wt. % or more, such as about 2 wt. % or more, such as about 3 wt. % or more, such as about 4 wt. % or more. In general, a retarder may be present in the plaster composition in an amount of about 5 wt. % or less, such as about 4 wt. % or less, such as about 3 wt. % or less, such as about 2 wt. % or less, such as about 1 wt. % or less, such as about 0.5 wt. % or less, such as about 0.4 wt. % or less, such as about 0.3 wt. % or less, such as about 0.2 wt. % or less, such as about 0.15 wt. % or less, such as about 0.1 wt. % or less, such as about 0.09 wt. % or less, such as about 0.08 wt. % or less, such as about 0.07 wt. % or less, such as about 0.06 wt. % or less, such as about 0.05 wt. % or less, such as about 0.04 wt. % or less, such as about 0.03 wt. % or less, such as about 0.02 wt. % or less.

Furthermore, the present invention is also directed to a method of making the aforementioned plaster composition and a hydrated plaster composition. In particular, the method may include a step of combining and mixing any of the aforementioned components to form a plaster composition. In particular, in one embodiment, the method may include a step of providing or combining and mixing one or more thickeners, one or more air entraining agents, one or more workability compositions, one or more binders, one or more stucco compositions, one or more retarders, and/or one or more stabilizers. Further, as previously disclosed herein, the method may include the grinding or milling of one or more workability compositions, such as by dry milling or wet milling. In one particular aspect, one or more workability compositions may be milled (e.g., ball milled) before being mixed or otherwise combined with the other components of the plaster composition.

Additionally, the method may include a step of hydrating or mixing the plaster composition with water to form a hydrated plaster composition. Notably, water may be present in an amount of about 10 wt. % or more, such as about 20 wt. % or more, such as about 30 wt. % or more, such as about 35 wt. % or more, such as about 40 wt. % or more, such as about 45 wt. % or more, such as about 50 wt. % or more based on the weight of the hydrated plaster composition. The water may be present in an amount of about 95 wt. % or less, such as about 90 wt. % or less, such as about 80 wt. % or less, such as about 70 wt. % or less, such as about 60 wt. % or less, such as about 55 wt. % or less, such as about 50 wt. % or less, such as about 45 wt. % or less, such as about 40 wt. % or less based on the weight of the hydrated plaster composition.

Notably, the hydrated plaster composition may have a particular solids content. For instance, the solids may constitute about 25 wt. % or more, such as about 30 wt. % or more, such as about 35 wt. % or more, such as about 40 wt. % or more, such as about 45 wt. % or more, such as about 50 wt. % or more of the hydrated plaster composition. The solids may constitute about 80 wt. % or less, such as about 75 wt. % or less, such as about 70 wt. % or less, such as about 65 wt. % or less, such as about 60 wt. % or less, such as about 55 wt. % or less, such as about 50 wt. % or less of the hydrated plaster composition.

Generally, the method of forming and applying the hydrated plaster composition may include a step of applying and/or spreading a hydrated plaster composition to a wall, ceiling, or more generally any surface (e.g., a building surface). Notably, the utilization of a thickener in accordance with the present disclosure may be particularly advantageous in the initial application and/or spreading of the hydrated plaster composition to a surface. After applying the hydrated plaster composition to a surface, a tool, such as a trowel, may be utilized to smooth the hydrated plaster composition. The utilization of a binder in accordance with the present disclosure may be particularly advantageous during the mixing of water with the plaster composition, during the initial application and/or spreading of the hydrated plaster composition, and/or during the initial smoothing of the hydrated plaster composition. The utilization of an air entraining agent in accordance with the present disclosure may be particularly advantageous during the mixing of water with the plaster composition, during the initial application and/or spreading of the hydrated plaster composition, and/or during the initial smoothing of the hydrated plaster composition. As the hydrated plaster composition hardens, the hydrated plaster composition may again be manipulated with a tool, such as a trowel, to further smooth the hardening hydrated plaster composition. Notably, water may be applied, such as by spraying, to the hydrated plaster composition during a smoothing step. The utilization of a workability composition in accordance with the present disclosure may be particularly advantageous during the smoothing of the hardening hydrated plaster composition. The hydrated plaster composition may then be allowed to dry and cure.

Notably, the hydrated plaster composition may include one or more thickeners, one or more air entraining agents, one or more workability compositions, one or more binders, one or more stucco compositions, one or more retarders, one or more stabilizers, or a combination thereof, in any amount, subrange, or range disclosed herein.

The plaster composition as mentioned herein may have applications in the building industry. For instance, the plaster composition may be available as a “ready-mix” formulation (ready to use without needing additional water). The plaster composition can be utilized with gypsum wallboards. In particular, the plaster compositions can be applied to gypsum wallboards. In addition, the plaster composition can be applied to any cracks, depressions, holes, and more generally any imperfections in a building surface. Such application of the plaster composition can provide a smooth, visually appealing surface.

In addition, with the use of the components as defined herein, the plaster composition may be generally regarded as a drying-type plaster composition. For instance, after application, the water evaporates and the composition dries to form a relatively hard cementitious material. Once hardened, the remaining material may be sanded to provide a smoother surface that may be later manipulated (e.g., painted).

### EXAMPLES

### Example 1

Three plaster compositions were made which included various amounts of various additives disclosed herein. The formulations of the three plaster compositions are illustrated in Table 1. As observed in Table 1, the amount of dolomitic slaked lime in the sample plaster compositions is significantly less than that of the comparative plaster composition. Further, Table 2 illustrates the reduction in CO₂ produced by Sample Plaster Composition 1 and Sample Plaster Composition 2 as compared to the comparative plaster composition.

TABLE 1

| | Comparative | | |
|---|---|---|---|
| | Plaster | Sample Plaster | Sample Plaster |
| | Composition | Composition 1 | Composition 2 |
| Additive | [wt. %] | [wt. %] | [wt. %] |
| Dolomitic Slaked Lime | 14.96 | 1.99 | 0.0 |
| 1-C Stucco | 44.89 | 44.77 | 44.77 |
| Gauging Stucco | 39.91 | 39.8 | 39.8 |
| Limestone | 0 | 13.0 | 15.0 |
| Stabilizer | 0.14 | 0.14 | 0.14 |
| Retarder | 0.09 | 0.04 | 0.04 |
| Cellulose Ether | 0.01 | 0.06 | 0.06 |
| Starch Ether | 0 | 0.03 | 0.03 |
| Air-Entraining Agent | 0 | 0.04 | 0.04 |
| Total | 100 | 100 | 100 |

TABLE 2

| | Comparative | | |
|---|---|---|---|
| | Plaster | Sample Plaster | Sample Plaster |
| | Composition | Composition 1 | Composition 2 |
| | [wt. %] | [wt. %] | [wt. %] |
| Dolomitic | 15.0 | 2.0 | 0.0 |
| Slaked Lime | | | |
| [wt. %] | | | |
| CO₂ Produced | 241.5 | 32.2 | 0.0 |
| [lbs] | | | |
| Reduction in CO₂ | 0.0 | 86.6 | 100 |
| Produced | | | |
| [%] | | | |

While particular embodiments of the present disclosure have been illustrated and described, it would be obvious to those skilled in the art that various other changes and modifications can be made without departing from the spirit and scope of the present disclosure. It is therefore intended to cover in the appended claims all such changes and modifications that are within the scope of this disclosure.

1. A plaster composition comprising:
a workability composition, the workability composition being present in the plaster composition in an amount from about 1 wt. % to about 40 wt. %; the workability composition having a median particle size from about 0.1 microns to about 60 microns; and
a binder.

2. The plaster composition of claim 1, wherein the workability composition comprises a metal carbonate in an amount of about 50 wt. % or more.

3. The plaster composition of claim 1, wherein the workability composition has a density from about 400 kg/m³ to about 1400 kg/m³.

4. The plaster composition of claim 1, wherein the workability composition is ground or milled.

5. The plaster composition of claim 1, wherein the plaster composition comprises slaked lime or dolomitic slaked lime in an amount less than about 20 wt. %.

6. The plaster composition of claim 1, wherein the plaster composition is substantially free of slaked lime or dolomitic slaked lime.

7. The plaster composition of claim 1, wherein the binder comprises a cellulose polymer.

8. The plaster composition of claim 1, wherein the binder is present in the plaster composition in an amount from about 0.001 wt. % to about 5 wt. %.

9. The plaster composition of claim 1, wherein the plaster composition further comprises a retarder.

10. The plaster composition of claim 9, wherein the retarder is present in the plaster composition in an amount from about 0.001 wt. % to about 5 wt. %.

11. The plaster composition of claim 1, wherein the plaster composition further comprises a thickener.

12. The plaster composition of claim 11, wherein the thickener is present in the plaster composition in an amount from about 0.001 wt. % to about 5 wt. %.

13. The plaster composition of claim 11, wherein the thickener has a viscosity from about 1 mPa·s to about 100 mPa·s.

14. The plaster composition of claim 1, wherein the plaster composition further comprises a first stucco composition in an amount from about 20 wt. % to about 80 wt. %.

15. The plaster composition of claim 1, wherein the plaster composition further comprises a first stucco composition, the first stucco composition having a calcium sulfate hemihydrate content of about 50 wt. % or more.

16. A plaster composition comprising:
a workability composition, the workability composition being present in the plaster composition in an amount from about 1 wt. % to about 40 wt. %, the workability composition having a particle size distribution such that from about 20% to about 80% of the workability composition by volume has a particle size of less than about 5.5 microns;
a binder; and
a first stucco composition.

17. A plaster composition comprising:
a workability composition, the workability composition being present in the plaster composition in an amount from about 1 wt. % to about 40 wt. %;
an air entraining agent, wherein at least one component of the air entraining agent has a carbon chain length from about 8 carbons to about 24 carbons; and
a first stucco composition.

18. The plaster composition of claim 17, wherein the air entraining agent has a median particle size from about 1 micron to about 300 microns.

19. The plaster composition of claim 17, wherein the air entraining agent has a bulk density from about 50 kg/m³ to about 600 kg/m³.

20. The plaster composition of claim 17, wherein the air entraining agent is present in the plaster composition in an amount from about 0.001 wt. % to about 5 wt. %.
